(19) United States
(12) Patent Application Publication
(10) Pub. No.: US 2010/0040840 A1
(43) Pub. Date: Feb. 18, 2010

(54) FILM FOR INSERT MOLDING AND RESIN-MOLDED ARTICLE USING THE SAME

(75) Inventors: Masato Saito, Saitama (JP); Masuo Koyama, Saitama (JP)

Correspondence Address: BACON & THOMAS, PLLC, 625 SLATERS LANE, FOURTH FLOOR, ALEXANDRIA, VA, 22314-1176, US

(73) Assignee: KIMOTO CO., LTD., SHINJUKU-KU (JP)

(21) Appl. No.: 12/528,711

(22) PCT Filed: Mar. 19, 2008
(86) PCT No.: PCT/JP2008/055090

§ 371 Date: Aug. 26, 2009

(30) Foreign Application Priority Data
Mar. 30, 2007 (JP) 2007-092424

(51) Int. Cl. B32B 3/10; C08G 18/28; C08F 22/10; B32B 27/40; B32B 27/30; B32B 7/12

(52) U.S. Cl. 428/195.1; 528/73; 526/321; 428/336; 428/423.1; 428/457; 428/354

(57) ABSTRACT

A film for insert molding comprising a base material film and a hard coat layer provided on at least one surface of the base material film, wherein the hard coat layer is formed from an ionizing radiation curable resin containing a reactive monomer having a cyclo ring structure containing at least one kind of element selected from carbon, nitrogen, oxygen, and silicon. The hard coat layer of this film for insert molding has sufficient surface hardness, and can prevent cracks which are likely to be generated at the time of molding (it has superior anti-cracking property).

### TECHNICAL FIELD

The present invention relates to a film for insert molding used for decoration or surface protection of various molded articles such as touch panels of home electrical appliances, operating parts (keypads) of equipments including cellular phones, game machines, sound reproducers, notebook PCs and so forth, in particular, a film for insert molding having sufficient hardness and anti-cracking hard coat property, and a resin-molded article using the same.

### BACKGROUND ART

As conventional means for imparting patterns or providing a surface protection layer on surfaces of various molded articles comprising a resin or the like, there are a method of, at the time of molding an article in a metallic mold, disposing a film comprising a base material and a printed layer or a surface protection layer formed on the base material between a resin and the metallic mold, transferring the printed layer or surface protection layer onto the surface of the molded article during molding, and then delaminating the base material, and a method of integrally molding a resin and such a film as mentioned above in a metallic mold.

Among the films used for these methods, those to be integrated with molded articles, not to be delaminated after molding, are called insert films or films for insert molding, which are distinguished from transfer films. As such insert films, there have been proposed, for example, films comprising a base material film such as a polyester film, a vapor-deposited metal film and a printed layer provided on one surface of the base material film, and a hard coat layer serving as a surface protection layer formed on the other surface of the base material film (Patent documents 1 and 2).

Patent document 1: Japanese Patent Unexamined Publication (KOKAI) No. 2005-288720
Patent document 2: Japanese Patent Unexamined Publication No. 2005-305786

### DISCLOSURE OF THE INVENTION

### Object to be Achieved by the Invention

Hard coat layers generally used for the purpose of surface protection of molded articles are required to have anti-scratching property, for example, hardness of 2H or higher in terms of pencil hardness, or 300 g load or higher as determined in a steel wool test. Therefore, such hard coat layers are constituted from curable resins showing superior anti-scratching property such as electron beam curable resins and ultraviolet curable resins. However, if a film on which such a hard coat layer is formed is used for insert molding, cracks may be generated on the hard coat surface. Since surfaces of molded articles generally have a curved surface or angles, it is hard to avoid generation of cracks.

To solve the above problem, it is conceivable to add a thermoplastic resin to the curable resin constituting the hard coat layer to increase plasticity thereof. However, in such a case, hardness is decreased with increase of plasticity, and the load used in such a steel wool test as mentioned above becomes unbearable to the hard coat layer.

Therefore, an object of the present invention is to provide a film for insert molding having a hard coat layer showing sufficient surface hardness and superior anti-cracking property.

### Means for Achieving the Object

In order to achieve the aforementioned object, the inventors of the present invention conducted various researches about the monomer of the curable resin constituting the hard coat layer. As a result, they found that a hard coat layer showing sufficient hard coat property and anti-cracking property can be formed by using a monomer having a cyclo ring structure in addition to a reactive group as a reactive monomer, and thus accomplished the present invention.

That is, the film for insert molding of the present invention is a film for insert molding comprising a base material film and a hard coat layer provided on at least one surface of the base material film, wherein the hard coat layer is formed from an ionizing radiation curable resin containing a reactive monomer having a cyclo ring structure containing at least one kind of element selected from carbon, nitrogen, oxygen, and silicon.

In the film for insert molding of the present invention, the cyclo ring may be, for example, a 5-membered ring or 6-membered ring.

In the film for insert molding of the present invention, the reactive monomer having a cyclo ring structure may be contained in the ionizing radiation curable resin at a ratio of 1 to 70% by weight.

In the film for insert molding of the present invention, the hard coat layer may have a thickness of, for example, 10 μm or smaller.

In the film for insert molding of the present invention, for example, at least one layer selected from a vapor-deposited metal layer, a printed layer and an adhesive layer may be formed on the surface of the other side of the base material film.

The resin-molded article of the present invention is a resin-molded article formed by integral molding of a molding material and a film for insert molding, wherein the film for insert molding is the aforementioned film for insert molding of the present invention.

In the resin-molded article of the present invention, the molding material may consist of, for example, one kind of material selected from an acrylic resin and a polycarbonate resin.

The ionizing radiation curable resin composition of the present invention is an ionizing radiation curable resin composition for forming hard coat film containing at least a photopolymerizable monomer, which contains a reactive monomer having a cyclo ring structure containing at least one kind of element selected from carbon, nitrogen, oxygen, and silicon as the photopolymerizable monomer.

The ionizing radiation curable resin composition of the present invention preferably contains 1 to 70% by weight of the reactive monomer having a cyclo ring structure.

The hard coat film of the present invention is a hard coat film obtained by curing a coated film of an ionizing radiation curable resin composition by irradiation of ionizing radiation, wherein the ionizing radiation curable resin composition of the present invention is used as the ionizing radiation curable resin composition.

### EFFECT OF THE INVENTION

According to the present invention, as a monomer of ionizing radiation curable resin constituting a hard coat layer of a film for insert molding, a monomer having a cyclo ring structure is used, thereby hard coat property corresponding to 300 g load or higher used in the steel wool test is obtained, and generation of cracks during molding can also be prevented. It is considered that this is because while the hard coat layer surface has a hardness which can bear the load used in the steel wool test, a flexible and tough structure is imparted to the resin by the cyclo ring, and therefore generation of cracks is prevented.

### BEST MODE FOR CARRYING OUT THE INVENTION

Hereafter, embodiments of the film for insert molding of the present invention will be explained.

The film for insert molding of the present invention comprises a base material film and a hard coat layer as the basic configuration. As the base material film, those showing superior transparency, heat resistance, and mechanical strength are preferred, and specific examples include those consisting of polyethylene terephthalate, polybutylene terephthalate, polyethylene naphthalate, polycarbonate, polyethylene, polypropylene, polystyrene, triacetyl cellulose, acrylic resin, polyvinyl chloride, norbornene compound, and so forth. A biaxially stretched polyester film is particularly preferably used in view of good dimensional stability thereof against heat.

The base material film may be subjected to a surface treatment such as adhesion promoting treatment so as to obtain favorable adhesion with the hard coat layer, and a vapor-deposited metal layer, a printed layer, or an adhesive layer.

Although thickness of the base material film is not particularly limited, it is about 20 to 200 μm, preferably about 50 to 150 μm, considering the handling property and mechanical strength thereof.

The hard coat layer will be explained below. The hard coat layer is formed from an ionizing radiation curable resin. An ionizing radiation curable resin generally contains a photopolymerizable prepolymer and/or a photopolymerizable monomer, which have a reaction group such as acryloyl group in the molecule, and is cured by crosslinking upon irradiation of ionizing radiation (ultraviolet ray or electron beam). In the present invention, a photopolymerizable monomer having a cyclo ring in addition to the polymerizable reaction group in the molecule is used as the photopolymerizable monomer for the hard coat layer.

The cyclo ring is constituted by at least one kind of element selected from carbon, nitrogen, oxygen, and silicon, and it is preferably a 5-membered ring or 6-membered ring. Specific examples of the cyclo ring structure include cycloolefins such as cyclopentene and cyclohexene, tetrahydrofuran, 1,3-dioxane, ε-caprolactone, 2-caprolactam, silacyclopentene, cyclodecane, isobornyl, and so forth. Examples of monomers having such a cyclo ring structure include ε-caprolactone-modified tris(2-acryloxyethyl) isocyanurate, ε-caprolactone-modified tris(2-hydroxyethyl) isocyanurate, dimethyloltricyclodecane di(meth)acrylate, isobornyl (meth)acrylate, tetrahydrofurfuryl (meth)acrylate, 2-acryloyloxyethyl hexahydrophthalate, and so forth.

The ionizing radiation curable resin can contain known photopolymerizable prepolymers and photopolymerizable monomers in addition to the aforementioned photopolymerizable monomer having the cyclo ring structure.

As such photopolymerizable prepolymers, acrylic type prepolymers such as urethane acrylates, polyester acrylates, epoxy acrylates, melamine acrylates, polyfluoroalkyl acrylates, and silicone acrylates can be used. As the photopolymerizable monomers, one or more kinds of monofunctional acrylic monomers such as 2-ethylhexyl acrylate, 2-hydroxyethyl acrylate, 2-hydroxypropyl acrylate and butoxyethyl acrylate, bifunctional acrylic monomers such as 1,6-hexanediol diacrylate, neopentylglycol diacrylate, diethylene glycol diacrylate, polyethylene glycol diacrylate and hydroxypivalic acid ester neopentylglycol diacrylate, polyfunctional acrylic monomers such as dipentaerythritol hexaacrylate, trimethylpropane triacrylate and pentaerythritol triacrylate, and so forth can be used.

The ratio of the photopolymerizable monomer having a cyclo ring structure to the total prepolymers and monomers constituting the ionizing radiation curable resin is preferably 1 to 70% by weight, more preferably 5 to 50% by weight. With a ratio of 1% by weight or larger, generation of cracks at the time of pressurization can be prevented. With a ratio of 70% by weight or smaller, decrease in the hardness of the hard coat layer can be prevented.

When the ionizing radiation curable resin is cured by ultraviolet irradiation, it is preferable to use additives such as a photopolymerization initiator and a photopolymerization enhancer besides the photopolymerizable prepolymers and photopolymerizable monomers mentioned above.

Examples of the photopolymerization initiator include acetophenone, benzophenone, Michler's ketone, benzoin, benzyl methyl ketal, benzoyl benzoate, α-acyl oxime ester, thioxanthones, and so forth. The photopolymerization enhancer can increase the curing rate by reducing polymerization disturbance caused by oxygen in the air at the time of curing, and examples include p-dimethylaminobenzoic acid isoamyl ester, p-dimethylaminobenzoic acid ethyl ester, and so forth.

Further, so long as the functions provided by the present invention are not degraded, other resins such as thermoplastic resins and thermosetting resins may be added to the hard coat layer as a binder component besides the aforementioned ionizing radiation curable resin. Specifically, a resin such as acrylic resin, polyester, polystyrene, polyvinyl acetate, polyurethane, or cellulose acetate can be added in an amount of about 30% by weight or smaller of the resin constituting the hard coat layer.

The hard coat layer may further contain additives such as matting agent for imparting anti-glaring function, colorant, antistatic agent, and UV absorbent.

The hard coat layer preferably has a thickness of about 0.5 to 10 μm, more preferably about 1 to 5 μm. If it exceeds 10 μm, it becomes likely that cracks or breakage are generated depending on shape of the hard coat layer.

The hard coat layer is formed by applying a coating solution prepared by mixing the aforementioned photopolymerizable prepolymer and photopolymerizable monomer, and the photopolymerization initiator, photopolymerization enhancer, and other additives added as required together with a dilution solvent to a base material film by a conventionally known method such as bar coating, die coating, blade coating, spin coating, roll coating, gravure coating, curtain flow coating, spray coating and screen printing, and curing the ionizing radiation curable resin by electron beam or ultraviolet irradiation. The hard coat layer is formed as a layer having a three-dimensionally reticular structure and showing high hardness and superior anti-cracking property by the electron beam or ultraviolet irradiation. It is considered that such characteristics can be obtained because when external pressure (bending force or tensile force) is applied, the cyclo ring structure in the molecule deforms to absorb such pressure and thereby prevent generation of cracks on the layer surface.

Although the basic configuration of the film of the present invention is constituted by the base material film and the hard coat layer mentioned above, a printed layer and vapor-deposited metal layer for decorating a molded article may be provided on the surface of the base material film on the side opposite to the side on which the hard coat layer was provided. An example of typical structure of the film for insert molding is shown in FIG. 1.

The film 10 for insert molding shown in the drawing has a structure that a hard coat layer 12 is formed on one surface of a base material film 11, and a decoration layer consisting of a vapor-deposited metal layer 13 and a printed layer 14, and an adhesive layer 15 are formed in this order on the other surface. Although a decoration layer produced by forming the vapor-deposited metal layer 13 on the base material film 11, and forming the printed layer 14 thereon is shown in the drawing, the configuration of the decoration layer is not limited to that shown in the drawing, and it may have various configurations. For example, after forming the vapor-deposited metal layer 13 on the base material film 11, a part of vapor-deposited metal layer 13 may be removed by etching, and printing may be performed on the portion of the base material film 11 from which the vapor-deposited metal layer 13 was removed, or desired characters or patterns may be formed on the base material film 11 by a known printing method such as silk screen printing, photogravure printing and ink-jet printing, and then the vapor-deposited metal layer 13 may be formed thereon. Moreover, the printed layer 14 may be omitted, and the vapor-deposited metal layer 13 may be directly formed on the base material film 11, or only the printed layer 14 may be provided without providing the vapor-deposited metal layer 13. When the printed layer 14 is provided, a receiving layer for receiving printing ink may be provided on the surface of the base material film 11 on which the printed layer 14 is formed.

The vapor-deposited metal layer 13 can be formed by vapor deposition of a metal such as aluminum, nickel, gold, platinum, chromium, iron, copper, tin, indium, silver, titanium, lead and zinc, or an alloy or compound thereof by a known method such as vacuum vapor deposition, sputtering and ion-plating.

The adhesive layer 15 is provided in order to enhance adhesion between the molded article material and the vapor-deposited metal layer 13, and adhesives such as those of polyurethane type, polyacrylate type, polyester type, epoxy type, polyvinyl acetate type, vinyl chloride/vinyl acetate copolymer type, and cellulose type can be suitably used according to type of the material of the molded article.

Embodiments of the film for insert molding of the present invention have been explained above. The ionizing radiation curable resin composition of the present invention is an ionizing radiation curable resin composition having the same configuration as that of the coating solution used for forming the hard coat layer of the film for insert molding described above. Specifically, it contains a photopolymerizable monomer as an essential component, and it contains, as the photopolymerizable monomer, a reactive monomer having a cyclo ring structure containing at least one kind of element selected from carbon, nitrogen, oxygen, and silicon. It further contains a photopolymerization initiator, a photopolymerization enhancer, and other additives as required. The individual components contained in the ionizing radiation curable resin composition are the same as the materials explained for the hard coat layer.

The ionizing radiation curable resin composition of the present invention can be used for forming a hard coat layer (cured film) for protecting surfaces of sheet-shaped members, molded articles, and so forth, besides the film for insert molding described above. Further, it is also possible to apply the ionizing radiation curable resin composition on a base material, or to make the ionizing radiation curable resin composition itself into a sheet shape to obtain a hard coat sheet.

The hard coat film of the present invention can be obtained by applying the ionizing radiation curable resin composition of the present invention on a member or base material to be protected, and curing it by irradiation of ionizing radiation such as electron beam and ultraviolet radiation. Since the hard coat film of the present invention is formed with the ionizing radiation curable resin composition containing the reactive monomer having a cyclo ring structure as a photopolymerizable monomer, it has anti-scratching property required for a hard coat film, and also has anti-cracking property against bending, and therefore it can be used for members of various shapes and uses to improve durability of these members.

An example of the method for producing a resin-molded article using the film for insert molding of the present invention will be explained below.

First, the film for insert molding of the present invention is disposed so that the hard coat layer should face outward on a resin-molded article, and subjected to a press working to mold it into a desired shape. Then, the molded film for insert molding is disposed in a metallic mold for molding, and a resin fluidized by heating is poured into the metallic mold. The molding conditions (temperature, pressure, time) are suitably chosen according to the resin (molding material). The resin may be a resin which can be molded by injection molding, and thermoplastic resins and thermosetting resins such as acrylic resins, polycarbonate resins, ABS resins and AS resins are used. The resin is cured and simultaneously integrated with the film for insert molding to obtain a resin-molded article of the present invention.

Since the resin-molded article of the present invention is formed by using a film having a hard coat layer showing superior anti-cracking property as the film for insert molding, it does not suffer from generation of cracks at the time of the press working of the film for insert molding and molding using a metallic mold, and has good appearance and superior anti-scratching property.

### EXAMPLES

Hereafter, the present invention will be explained in more detail with reference to examples. The term “part” and the symbol “%” are used on weight basis unless especially indicated.

### Example 1

A coating solution for hard coat layer having the following composition was applied by bar coating to one surface of a polyester film having a thickness of 125 μm (COSMOSHINE A4300, Toyobo Co., Ltd.) as a base material film, dried at 90° for 1 minute, and then irradiated with ultraviolet radiation with a high pressure mercury vapor lamp (irradiation dose: 300 mJ/cm²) to form a hard coat layer having a thickness of 3 μm, and thereby obtain a film for insert molding of Example 1. In the following composition, content of the reactive monomer containing a cyclo ring structure was about 33% by weight relative to the total ionizing radiation curable resin composition containing the reactive monomer containing a cycle ring structure.

### <Composition of Coating Solution for Hard Coat Layer of Example 1>

| | | |
|---|---|---|
| ε-Caprolactone-modified tris(2-hydroxyethyl) | 5 | parts |
| isocyanurate (SR368, Sartomer Co., Inc., | | |
| solid content: 100%) | | |
| Ionizing radiation curable resin composition | 10 | parts |
| (solid content: 100%, Beamset 575, | | |
| Arakawa Chemical Industries, Ltd.) | | |
| Photopolymerization initiator | 0.4 | part |
| (Irgacure 651, Ciba Speciality | | |
| Chemicals Inc.) | | |
| Propylene glycol monomethyl ether | 30 | parts |

### Example 2

A film for insert molding of Example 2 was obtained in the same manner as that of Example 1, except that the amounts of the reactive monomer having a cycle ring structure and the ionizing radiation curable resin composition in the coating solution for hard coat layer of Example 1 were changed to 1 part and 14 parts, respectively. In the aforementioned composition, content of the reactive monomer having a cyclo ring structure was about 6.7% by weight relative to the total ionizing radiation curable resin composition containing the reactive monomer having a cycle ring structure.

### Example 3

A film for insert molding of Example 3 was obtained in the same manner as that of Example 1, except that the amounts of the reactive monomer having a cyclo ring structure and the ionizing radiation curable resin composition in the coating solution for hard coat layer of Example 1 were changed to 10 part and 5 parts, respectively. In the aforementioned composition, content of the reactive monomer having a cyclo ring structure was about 67% by weight relative to the total ionizing radiation curable resin composition containing the reactive monomer having a cyclo ring structure.

### Example 4

A film for insert molding of Example 4 was obtained in the same manner as that of Example 1, except that the reactive monomer having a cyclo ring structure in the coating solution for hard coat layer of Example 1 was changed to dimethyloltricyclodecane diacrylate (Light Acrylate DCP-A, Kyoeisha Chemical Co., Ltd.).

### Comparative Example 1

A film for insert molding of Comparative Example 1 was obtained in the same manner as that of Example 1, except that the reactive monomer having a cyclo ring structure was not added, and the amount of the ionizing radiation curable resin composition was changed to 15 parts in the coating solution for hard coat layer of Example 1.

### Comparative Example 2

A film for insert molding of Comparative Example 2 was obtained in the same manner as that of Example 1, except that the coating solution for hard coat layer of Example 1 was changed to a coating solution for hard coat layer having the following composition.

### <Composition of Coating Solution for Hard Coat Layer of Comparative Example 2>

| | |
|---|---|
| Thermoplastic acrylic resin (ACRYDIC A195, | 12.5 parts |
| Dainippon Ink & Chemicals, Inc., | |
| solid content: 40%) | |
| Ionizing radiation curable resin composition | 10 parts |
| (solid content: 100%, Beamset 575, | |
| Arakawa Chemical Industries, Ltd.) | |
| Photopolymerization initiator | 0.4 part |
| (Irgacure 651, Ciba Speciality | |
| Chemicals Inc.) | |
| Propylene glycol monomethyl ether | 22.5 parts |

The films for insert molding obtained in the examples and the comparative examples were evaluated for hard coat property and anti-cracking property. The results are shown in Table 1.

### (1) Evaluation of Hard Coat Property

The surface of the hard coat layer was reciprocally rubbed 10 times with steel wool of #0000 at a load of 300 g, and then presence or absence of scratches on the surface was evaluated by visual inspection. The evaluation results are indicated with “⊚” when there was no scratch, with “◯” when there was few scratch, and with “X” when there were conspicuous scratches.

### (2) Evaluation of Anti-Cracking Property

According to the flex resistance test method (cylindrical mandrel method, JIS K5600-5-1:1999), the films for insert molding obtained in the examples and the comparative examples were bent and wound around an iron bar having a diameter of about 5 mm so that the hard coat layer should face outward, and whether cracks were generated in the wound portion or not was evaluated by visual inspection. The evaluation results are indicated with “⊚” when cracks could not be confirmed, with “◯” when few crack could be confirmed, and with “X” when cracks were confirmed.

TABLE 1

| | Hard coat | Anti-cracking |
|---|---|---|
| | property | property |
| Example 1 | ⊚ | ⊚ |
| Example 2 | ⊚ | ◯ |
| Example 3 | ◯ | ⊚ |
| Example 4 | ⊚ | ⊚ |
| Comparative | ⊚ | X |
| Example 1 | | |
| Comparative | X | ◯ |
| Example 2 | | |

As seen from the results shown in Table 1, all the films for insert molding of the examples, which used the specific reactive monomers as the monomer of the resin constituting the hard coat layer, showed superior hard coat property and anti-cracking property.

On the other hand, the film for insert molding of Comparative Example 1, which did not use the specific reactive monomer, showed poor anti-cracking property, and generation of cracks in the flex resistance test by the mandrel method, although it showed superior hard coat property. Further, the film for insert molding of Comparative Example 2 in which a thermoplastic resin was added to the ionizing radiation curable resin, hard coat property was degraded, although flexibility of the hard coat layer could be improved.

### Example 5

The film for insert molding produced in Example 1 was incorporated into a mold for injection molding so that the hard coat layer should face outward on a resin-molded article to be produced, and then molded into a three-dimensional shape by vacuum molding. Subsequently, a melted acrylic resin was poured into the metallic mold, the metallic mold was cooled, and an acrylic resin-molded article integrally cured with the film for insert molding was taken out.

When the edge portions of this acrylic resin-molded article were observed by visual inspection, it was confirmed that there were no generation of cracks and no whitening, the film for insert molding and the acrylic resin were integrated along the shape of the molded article, and the transparency thereof was maintained. Further, when hard coat property of this acrylic resin-molded article was evaluated in the same manner as that use for the films for insert molding, the same result as that of Example 1 was obtained.

### INDUSTRIAL APPLICABILITY

According to the present invention, a film for insert molding showing superior anti-cracking property and hard coat property is provided. By using this film for insert molding, molded articles of various shapes can be produced without generating cracks. Moreover, the obtained molded article shows superior hard coat property, and molding material and the film for insert molding are not delaminated even after lapse of time.

### BRIEF DESCRIPTION OF THE DRAWING

FIG. 1 A drawing showing an example of a structure of film for insert molding to which the present invention is applied.

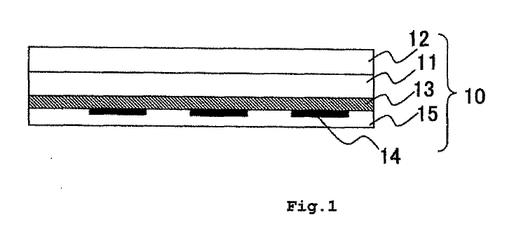

### EXPLANATION OF NUMERAL NOTATIONS

10 . . . . Film for insert molding, 11 . . . base material film, 12 . . . hard coat layer, 13 . . . vapor-deposited metal layer, 14 . . . printed layer, 15 . . . adhesive layer.

1. A film for insert molding comprising a base material film and a hard coat layer provided on at least one surface of the base material film, wherein the hard coat layer is formed from an ionizing radiation curable resin containing a reactive monomer having a cyclo ring structure containing at least one kind of element selected from carbon, nitrogen, oxygen, and silicon.

2. The film for insert molding according to claim 1, wherein:
the cyclo ring is a 5-membered ring or 6-membered ring.

3. The film for insert molding according to claim 2, wherein:
the reactive monomer having a cyclo ring structure is contained in the ionizing radiation curable resin in the amount of 1 to 70% by weight.

4. The film for insert molding according to claim 1, wherein:
the hard coat layer has a thickness of 10 μm or smaller.

5. The film for insert molding according to claim 1, wherein:
at least one layer selected from a vapor-deposited metal layer, a printed layer and an adhesive layer is formed on the surface of the other side of the base material film.

6. A resin-molded article formed by integral molding of a molding material and a film for insert molding, wherein the film for insert molding is the film for insert molding according to claim 5.

7. The resin-molded article according to claim 6, wherein the molding material consists of one of an acrylic resin and a polycarbonate resin.

8. An ionizing radiation curable resin composition for forming hard coat film containing at least a photopolymerizable monomer, which contains a reactive monomer having a cyclo ring structure containing at least one element selected from carbon, nitrogen, oxygen, and silicon as the photopolymerizable monomer.

9. The ionizing radiation curable resin composition according to claim 8, which contains 1 to 70% by weight of the reactive monomer having a cyclo ring structure.

10. A hard coat film obtained by curing a coated film of an ionizing radiation curable resin composition by irradiation of ionizing radiation, wherein the ionizing radiation curable resin composition according to claim 9 is used as the ionizing radiation curable resin composition.

11. The film for insert molding according to claim 1, wherein:
the reactive monomer having a cyclo ring structure is contained in the ionizing radiation curable resin in the amount of 1 to 70% by weight.

12. A resin-molded article formed by integral molding of a molding material and a film for insert molding, wherein the film for insert molding is the film for insert molding according to claim 1.

13. The resin-molded article according to claim 12, wherein the molding material consists of one of an acrylic resin and a polycarbonate resin.

14. A hard coat film obtained by curing a coated film of an ionizing radiation curable resin composition by irradiation of ionizing radiation, wherein the ionizing radiation curable resin composition according to claim 8 is used as the ionizing radiation curable resin composition.
